(19) United States
(12) Patent Application Publication
(10) Pub. No.: US 2001/0025254 A1
(43) Pub. Date: Sep. 27, 2001

(54) Electronic stamp providing system for online advertisement and method of operating thereof

(76) Inventor: Choon-Woo Park, Kyonggi-do (KR)

Correspondence Address: ROBERT E. BUSHNELL, 1522 K STREET NW, SUITE 300, WASHINGTON, DC, 200051202

(21) Appl. No.: 09/797,576

(22) Filed: Mar. 5, 2001

(30) Foreign Application Priority Data
Mar. 9, 2000 (KR) 2000-11845

(51) Int. Cl. G06F 17/60

(52) U.S. Cl. 705/14

(57) ABSTRACT

The electronic stamp providing system provides a customized online advertisement to an electronic mail receiver by using a data transmission network such as the Internet. The electronic stamp providing system gives an electronic stamp which combines a stamp image and identification information. A transmitter appends the electronic stamp to an electronic mail message by using an electronic stamp program, and a receiver of the message connects to the electronic stamp providing system through the electronic stamp contained in the electronic mail, and the electronic stamp providing system delivers the customized online advertisement on the basis of personal information provided by the receiver only in case that there is a request by the receiver. The electronic stamp providing system can provides a customized advertisement only in the case that the receiver wants to receive the online advertisement.

his application makes reference to, incorporates the same herein, and claims all benefits accruing under 35U.S.C.119 from an application for ELECTRONIC STAMP PROVIDING SYSTEM FOR ONLINE ADVERTISEMENT AND METHOD OF OPERATING THEREOF, earlier filed in the Korean Industrial Property Office on Mar. 9, 2000 and there duly assigned Serial No. 2000-11845.

### BACKGROUND OF THE INVENTION

1. Field of the Invention

The present invention relates to an online advertisement system using a data transmission network; and more particularly, to an electronic stamp-providing system and a method of operating thereof, in which a customized online advertisement can be delivered to electronic mail receivers.

2. Description of Related Art

The development of computer-based communication technology has brought about various kinds of online services, e.g., personal or enterprise homepages, content providers, online shopping malls, etc., through the Internet. The above-mentioned web sites on the Internet are being formed in a new area, that of online advertisement, directed to the increasing number of Internet users.

Among online advertisements through the Internet, there is a banner type advertisement provided in a web site, and an electronic catalogue provided by electronic mail, etc., besides, various online advertisement techniques are provided.

Early online advertisement mainly involved providing a banner type online advertisement in which a simple advertisement image and text were carried in a web page, and a link for inducing an online connection was given onto a corresponding advertisement image or text so that Internet users might be induced to be moved to a web page of an advertising owner. More recently, banner advertisements of a more advanced type using images having motion have been provided.

However, such a banner advertisement system is provided by a simply disclosed type in the web page; thus there is a problem that the advertisement effect is lost if the Internet user moves to another web page. Further, since numerous banner advertisements are given in one web page, not only does the user lose concentration on a specific advertisement, but also the Internet user may be under mental stress owing to the excessive banner advertisement.

In order to overcome disadvantages of the banner advertisement having such web site visitors as the main objects thereof and to provide online advertisement on the Internet more effectively, an advertising technique using electronic mail is being utilized.

In the technique of online advertisement using electronic mail, there are systems of directly transmitting advertisement to a personal electronic address from an advertisement service provider, as a direct e-mail system; adding the advertisement onto the advertisement service provider's own transmission electronic mail by using a specific program provided by the advertisement service provider, and sending it; and optionally imbedding the advertisement in the electronic mail by the advertisement service provider through a use of an electronic mail function of free charge, etc. Such online advertisement using the electronic mail has a prominent effect in comparison with the advertisement using the web site, but the following problems are caused.

The system of directly transmitting the advertisement to the personal electronic mail may be perceived as spam mail by the receiver, thus a negative impression may be given to the imagination of an advertising owner enterprise. Further, in a transmission of many advertisements, the advertising effect may decrease since the effect is not customized on the basis of a characteristic of the receiver. Also, in a case of the system using the electronic mail which is free of charge, a customized online advertisement is not provided since in this system the service provider optionally imbeds the advertisement in the electronic mail. In the system where an individual adds the advertisement to the electronic mail and sends it, a mail transmitter must subscribe as a member in a web site of a decided advertising service enterprise and must receive a download of a specific program for appending the advertisement thereto, and a user must directly embed the advertisement in the electronic mail by using this downloaded program. Performed in this manner, the procedure of transmitting the advertisement by containing the advertisement in the electronic mail is very inconvenient.

As described above, advertisement using electronic mail overcomes the shortcomings of the banner type advertisement, but the above-mentioned disadvantages are caused. Technical endeavor is continuously required to overcome the disadvantages of such online advertisement and more effectively carry the online advertisement on the Internet. As an example, U.S. Pat. No. 5,933,811, to Paul D. Angles et al., entitled “System and method for delivering customized advertisements within interactive communication systems”, describes a system in which an advertisement provider provides a customized advertisement to a computer of a client on the basis of a client profiles in an interactive system environment. However, even though such customized advertisement is provided, the online advertisement is given without this being the intention of the online user contacted with the advertisements. This may lead to a negative reaction of the contacted user.

### SUMMARY OF THE INVENTION

It is therefore an object of the invention to provide a system and method for online advertisement.

Another object of the invention is to provide a system and method for online advertisement using electronic mail.

Yet another object of the invention is to provide an online advertisement method which does not involve “spam” mail.

A further object of the present invention to provide an online advertisement system capable of providing a customized online advertisement with a consideration for a selection of a user who contacts the online advertisement.

In accordance with the present invention for achieving the above objects, in one characteristic, an electronic stamp providing system includes an electronic stamp program for providing an electronic stamp containing a stamp image, identification information, and a link to be connected to the electronic stamp providing system, and appending the electronic stamp to an electronic mail generated by an electronic mail program; a database server for storing the identification information of the electronic stamp, information of a transmitter and a receiver using the electronic stamp, and transmission information of online advertisement; and an electronic stamp server for performing an overall control of the electronic stamp providing system, and providing a customized online advertisement to the receiver on the basis of the receiver information of the database server when the receiver of the electronic mail containing the electronic stamp replies to a reception of the online advertisement.

In this embodiment, the electronic stamp program provides the transmitter information containing the delivery number of the electronic stamp and electronic mail address of the transmitter to the electronic stamp server after a transmission of the electronic mail with the electronic stamp, and the electronic stamp server stores the received transmitter information at the database server.

Herewith, the identification information contains an identification (ID) field of a user, an electronic mail ID field of the user, an ID field of a stamp graphic copyright holder, a server ID field having a download of the electronic stamp program, a provider ID field of an electronic mail service, and an address ID field of a server to be connected after the reception.

This identification information is constructed by one unique, or peculiar, representative ID specific in the electronic stamp. Information, which contains the ID field of user, the electronic mail ID field of the user, the ID field of the stamp graphic copyright holder, the server ID field having the download of the electronic stamp program, the provider ID field of the electronic mail service, and the address ID field of the server to be connected after the reception, which correspond to the representative ID, is stored at the database server.

Herewith, the delivery information for the online advertisement selectively given to the receiver of the electronic mail containing the electronic stamp is stored as online advertisement delivery information at the database server.

In another characteristic of the present invention, a method of operating an electronic stamp providing system includes the steps of: appending an electronic stamp given from an electronic stamp program to an electronic mail generated by an electronic mail program; transmitting the electronic mail with the electronic stamp; receiving the electronic mail with the electronic stamp; providing an online advertisement to a receiver according to a selection of the receiver of the electronic mail having the electronic stamp; and storing advertisement delivery information for the online advertisement given to the receiver at a database server, wherein the electronic stamp providing system contains an electronic stamp program for providing the electronic stamp containing a stamp image, identification information, and a link to be connected to the electronic stamp providing system; the database server for storing the identification information of the electronic stamp, information of a transmitter and a receiver using the electronic stamp, and transmission information of the online advertisement; and an electronic stamp server for performing an overall control of the electronic stamp providing system.

In this embodiment, there is contained a step that, the electronic stamp program in the midst of execution under an inactivation state is changed to an activation state when the electronic mail program is executed in a transmitter system.

Herewith, there are also steps that transmitter information containing the delivery number of electronic mail having the electronic stamp and also containing the electronic mail address of transmitter is provided to the electronic stamp server, and the transmitter information provided to the electronic stamp server is stored at the database server.

In addition, there are steps of deciding whether or not the receiver selects the electronic stamp appended to the electronic mail, and providing the online advertisement by the electronic stamp server to the receiver in case that the receiver selects the electronic stamp.

Herewith, it is contained a step of checking a reception intention of the receiver for the online advertisement before a delivery of the online advertisement, so that the online advertisement can be provided in case that the receiver selects the reception of the online advertisement.

Before providing the online advertisement, it is also provided the steps of receiving receiver information from the receiver and providing the customized online advertisement from the electronic stamp server to the receiver on the basis of the receiver information.

There is further contained a step of requesting an advertising owner to pay advertising charge on the basis of the advertisement delivery information stored at the database server.

### BRIEF DESCRIPTIONS OF THE DRAWINGS

The above and other objects and features of the instant invention will become apparent from the following description of preferred embodiments taken in conjunction with the accompanying drawings, in which:

FIG. 1 depicts a block diagram showing an overall construction of an electronic stamp providing system in accordance with the present invention;

FIG. 2 is a diagram showing the construction of an electronic mail containing an electronic stamp provided by an electronic stamp program of FIG. 1;

FIG. 3 is a flowchart for a general operating order of an electronic stamp providing system in the present invention;

FIG. 4 represents a flowchart for a detailed procedure of sending an electronic mail containing an electronic stamp;

FIG. 5 is a diagram showing a screen display of an electronic mail program and an activated electronic stamp program;

FIG. 6 indicates a diagram illustrating a procedure of providing an electronic stamp from an electronic stamp providing system to a user system;

FIG. 7 sets forth a flowchart showing in detail a procedure of receiving an electronic mail and its selective advertisement; and

FIG. 8 is a diagram for one example of a selective advertisement reception generated through an electronic stamp contained into an electronic mail.

### DETAILED DESCRIPTION OF THE INVENTION

Reference will now be made in detail to the preferred embodiments of the present invention, examples of which are illustrated in the accompanying drawings.

In accordance with the present invention, an electronic stamp providing system for a new online advertisement selectively provides a customized online advertisement to electronic mail receivers by containing a new type electronic stamp having a stamp image and identification information into an electronic mail.

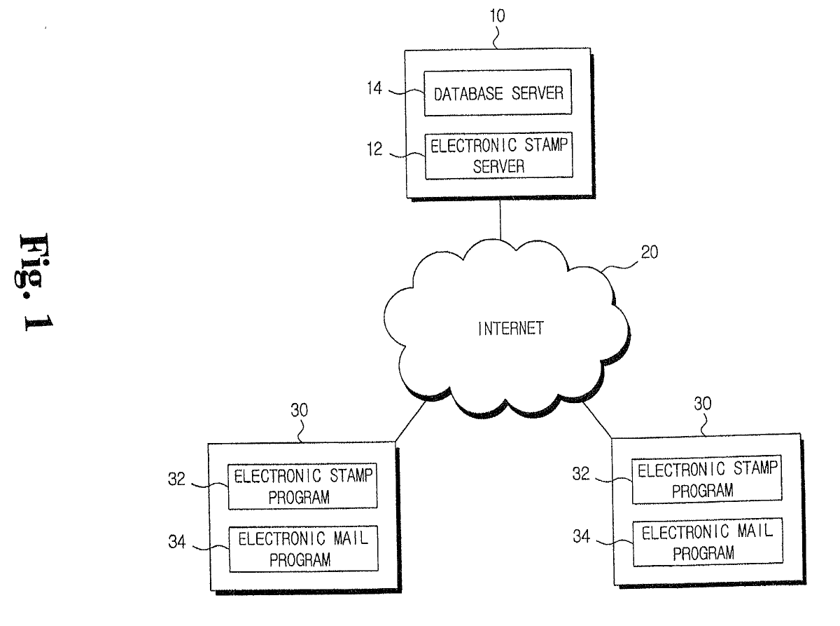

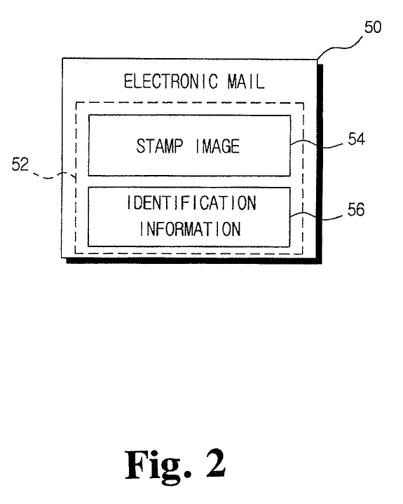

FIG. 1 is a block diagram showing an overall construction of the inventive electronic stamp providing system, and FIG. 2 is a diagram showing the construction of the electronic mail containing the electronic stamp provided by an electronic stamp program of FIG. 1.

With reference to the drawings, an inventive electronic stamp providing system 10 is constructed by an electronic stamp server 12 and a database server 14, which are connected to an Internet 20. The electronic stamp server 12 provides an electronic stamp program 32 and various and customized online advertisements using the electronic stamp. The database server 14 stores information of a transmitter and a receiver using the electronic stamp, several kinds of information concerned with the electronic stamp as identification information peculiar to the electronic stamp to be later mentioned, and information for the online advertisements given. A user system 30 may be constructed, for instances, of a personal computer having an installed modem, and the electronic stamp program 32 provided from the electronic stamp server 12 through the Internet 20 is installed in the user system 30. The user's system may be, in general, any system capable of transmitting and receiving electronic mail, and may also be, for example, a cellular phone or handheld device. The electronic stamp program 32 is provided from the electronic stamp providing system 10, or may be also supplied through another cooperating web site.

An electronic stamp program 34 is installed in the user system to append an electronic stamp 52 to an electronic mail generated by the electronic mail program 34. FIG. 1 illustrates two user systems 30 each having an electronic stamp program 32 and an electronic mail program 34. However, for the operation of the present invention, only one user need have an electronic mail program.

The electronic stamp 52 appended to the electronic mail contains a stamp image 54, identification information 56 and a link to be connected to the electronic stamp providing system 10. The stamp image 54 is a graphical image or icon displayed on a device of the user. In the identification information 56 contained in the electronic stamp 52, there are, for example, an ID(identification) field of a user, an electronic mail ID field of the user, an ID field of a stamp graphic copyright holder, an ID field of a server having a download of the electronic stamp program, a provider ID field of an electronic mail service, and an address ID field of a server to be connected after the reception. Additional ID fields can be contained therein if necessary. A representative ID field for binding such serial ID fields in one bundle may be given, thereby one electronic stamp has one representative ID so as to provide a uniqueness, or peculiarity, to individuals of the electronic stamps circulated in the Internet. The identification information 56 contains only the representative ID and the other ID field information may be stored at the database server 14 of the electronic stamp providing system 10.

Since the electronic stamp 52 does not contain directly-concerned advertisement contents, the transmission capacity of the electronic mail can be minimized. In a case of the stamp image 54, the transmission capacity of the electronic mail may be further minimized by loading the stamp image 54 from the electronic stamp providing system 10. The stamp image 54 can be presented or used in various ways according to a selection of the user by combining and constructing one or more of a stop screen, animation, a mobile image video and sound, etc.

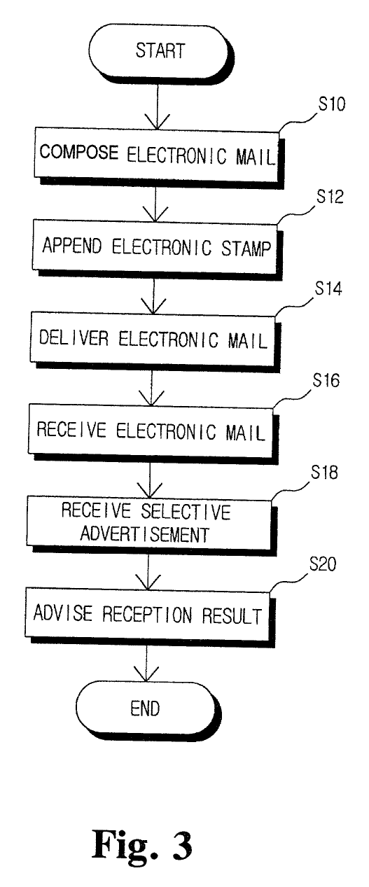

FIG. 3 is a flowchart showing an order of overall operations in the inventive electronic stamp providing system. Though this embodiment will be described as follows, with one example for a POP3 electronic mail, it will be understood by those skilled in this art that the invention may be readily applied to WEB electronic mail, radio or wireless electronic mail, such as with a PCS or cellular phone, etc., as examples of electronic mail provided in various types of data transmission networks.

Referring to the drawing, in a step S10, a user composes the electronic mail 50 by using the electronic mail program 34. This electronic mail program may be, for example, Outlook Express of Microsoft Corporation, or another electronic mail program. In a step S12, the user appends the electronic stamp 52 provided from the electronic stamp program 32 to the electronic mail 50. In a step S14, the electronic mail 50 composed using the electronic mail program 34 is transmitted.

In a step S16, a corresponding receiver receives the electronic mail 50 containing the electronic stamp 52, and according to a selection of the receiver, a customized advertisement is selectively received in a step S18. As will be explained later, the receiver can receive the advertisement by merely clicking the stamp image 54 of the electronic stamp 52 contained into the received electronic mail 50 through a use of a mouse. Herewith, the provided advertisement is the advertisement customized on the basis of user information stored at the database server 14 of the electronic stamp providing system 10. If it is a case that there is no user information at the database server 14, a procedure of receiving the user information of the receiver may be performed before a delivery of the advertisement, which will be described later. Then, in a step S20, an advertisement reception result, which is an additional transmission from the receiver's system, is sent to the electronic stamp providing system 10.

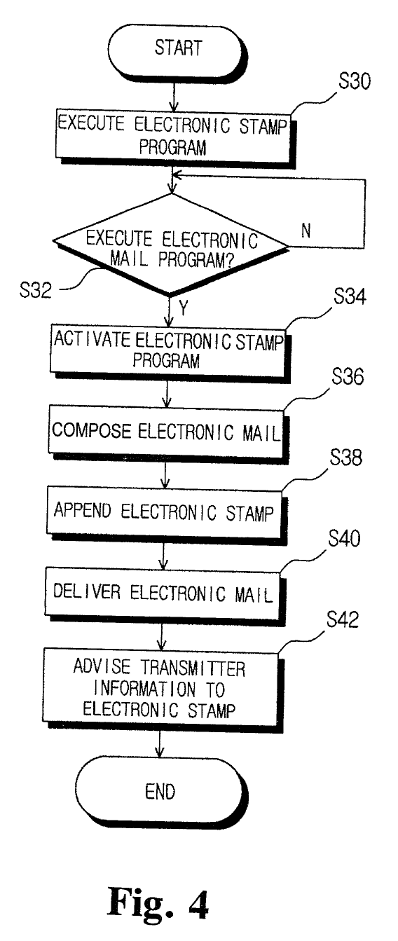

Through the above procedures, the user can transmit the electronic stamp appended to the electronic mail, and the receiver can selectively receive the customized advertisement through the appended electronic stamp. The inventive electronic stamp providing system will be described in more detail with reference to FIGS. 4 through 8.

FIG. 4 is a flowchart showing a procedure of transmitting the electronic mail with the electronic stamp more in detail.

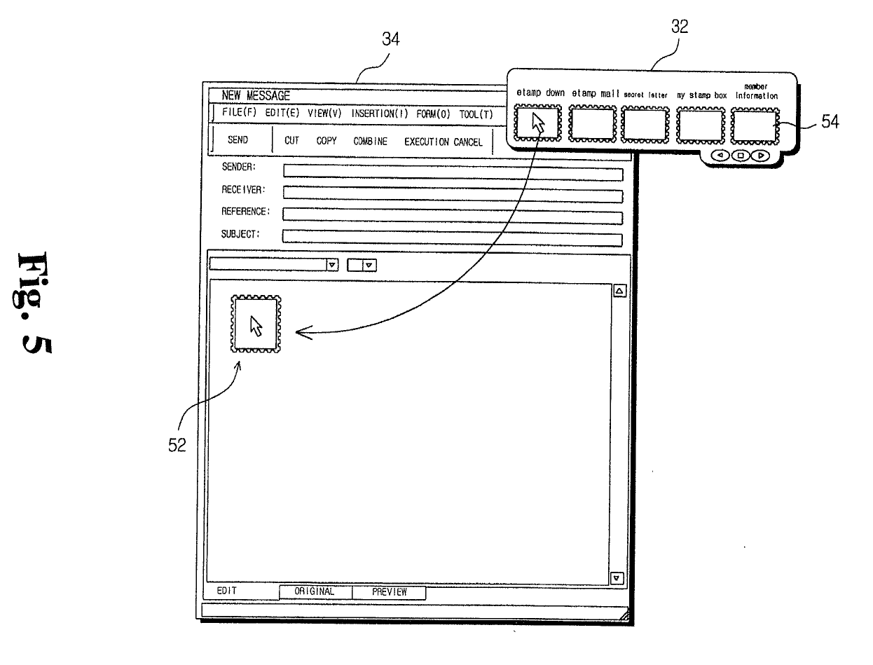

Referring to the drawing, when the user system having the installment of the electronic stamp program operates, the electronic stamp program 32 is executed in a step S30 and it is changed to an inactivation state. The inactivation state refers to a state where the stamp program does not cause a window to be displayed in the graphical user interface of the user's system. That is, a window may be displayed when the system is in the activation state, and the window may be “minimized” when the window is in the inactivation state. The electronic stamp program 32 changed to the inactivation state decides in a step S32 whether or not the electronic mail program 34 is executed. When the electronic mail program 34 is executed, the electronic stamp program 32 is changed from the inactivation state to an activation state. FIG. 5 represents the electronic mail program 34 and the activated electronic stamp program 32.

The user composes the electronic mail by using the electronic mail program 34 in a step S36, and appends the electronic stamp 52 provided by the electronic stamp program 32 to the electronic mail in a step S38. The user selects one out of numerous stamp images 54 provided by the electronic stamp program 32, and can drag and append it to an electronic mail making area of the electronic mail program 34 by using an automatic appending function or by using a drag-and-drop function by manual use of a mouse. In the embodiments illustrated in the figures, electronic stamp image 54 takes the form of a perforated stamp, but other graphical images may be used. In such a procedure of imbedding the electronic stamp image 54 in the electronic mail, a representative ID of the electronic stamp 52 is imbedded in a text header of the electronic mail 50. Since the electronic stamp 52 contains a link to be connected to the electronic stamp providing system 10, the receiver can selectively receive the advertisement by clicking the stamp image contained into the received electronic mail through a use of a mouse, which will be described layer.

In a step S40, the electronic mail with the electronic stamp is transmitted by using the electronic mail program 32. When the electronic mail is transmitted, the electronic stamp program 32 informs the electronic stamp providing system 10 of the transmitter information, e.g., an electronic mail address of the transmitter and the number of electronic mail deliveries using the electronic stamp, in a step S42. The transmitted transmitter information is stored at the database server 14 of the electronic stamp providing system 10.

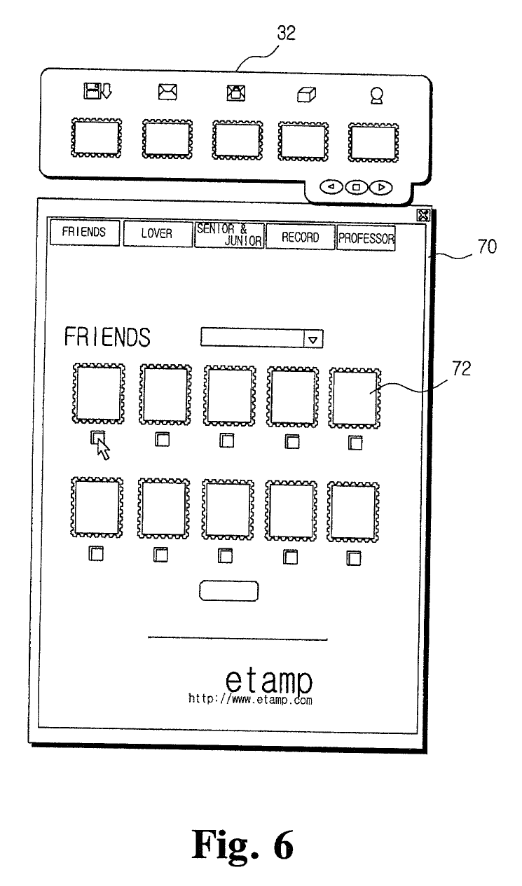

FIG. 6 is a drawing for a procedure of providing the electronic stamp from the electronic stamp providing system to the user system.

With reference to FIG. 6, the electronic stamp program 32 may additionally receive various electronic stamp images 72 from the electronic stamp providing system 10. If the electronic stamp program 32 requests the electronic stamp providing system 10 to additionally send the electronic stamp, an electronic stamp providing window 70 for the additional electronic stamp is opened, and through that, a stamp image 72 can be added. Further, the stamp image 54 can be designed by the user, and a stamp image designed by an individual can be registered in the electronic stamp providing system 10 and can be distributed. In this manner, since the electronic stamp is directly selected or made by the user oneself, the user may express a unique or peculiar image and the personality of the user can be expressed, and there is also an additional effect of promoting a relation between the transmitter and the receiver. In addition, there is an effect of utilizing the stamp as a medium of a cultural and economic value transfer by circulating the electronic stamp online.

Through such procedures, the user can simply append the electronic stamp provided by the electronic stamp program to the electronic mail by using the drag-and-drop function, and can transmit it. Subsequently, procedures of receiving the electronic mail with the electronic stamp and selectively receiving the customized advertisement using the electronic stamp will be described more in detail.

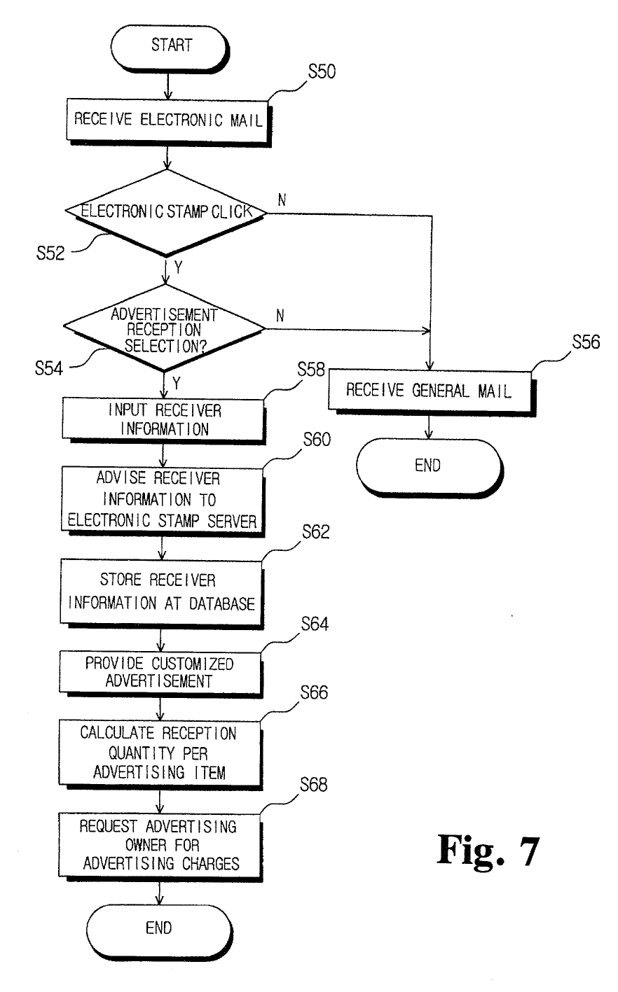

FIG. 7 is a flowchart showing a detailed procedure of receiving the electronic mail and selectively receiving the advertisement through the electronic mail.

With reference to FIG. 7, in a step S50, the receiver receives the electronic mail containing the electronic stamp. When the user clicks the electronic stamp contained into the electronic mail by using the mouse in a step S52, a guide message for checking whether or not the online advertisement will be received is displayed on a monitor screen of the receiver in a step S54. In case that the electronic stamp is not clicked, a general mail receiving procedure is progressed in a step S56.

In the case where the advertisement reception is selected in the step S54, a receiver information inputting step is performed in a step S58. That is, the receiver manually inputs personal information. In a step S60, the inputted receiver information is sent to advise the electronic stamp server. The input of the receiver information is to provide the customized advertisement. In case that the receiver information was already stored at the database server 14 of the electronic stamp providing system 10, its input can be omitted, and only in case additional information is needed, the input of the receiver information can be required. In a step S62, the electronic stamp providing system 10 stores the received receiver information at the database server 14.

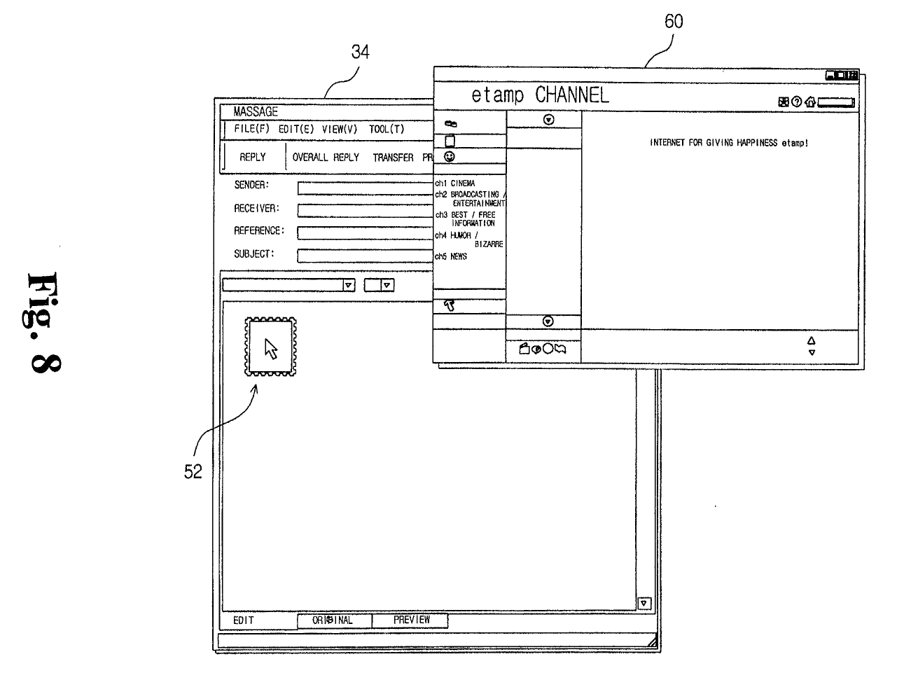

In a step S64, the electronic stamp providing system 10 sends the advertisement customized on the basis of the receiver information to the receiver who selected a reception of the advertisement. One example of such selective advertisement reception generated through the electronic stamp contained into the electronic mail is shown in FIG. 8. If the receiver selects the advertisement reception, as shown in the drawing an advertisement providing window 60 for providing the advertisement is opened and the customized advertisement provided from the electronic stamp providing system 10 is displayed on the advertisement providing window 60. The receiver may contain in the advertisements displayed on the advertisement providing window 60, various online marketing promotion contents such as a products direct sale, a banner type advertisement, a moving image advertisement, a premium, a lottery ticket, an electronic catalogue, quiz, a game, and a survey of public opinion, etc.

Successively, in a step S66, a reception quantity per advertisement item received by the receiver is calculated, and this calculation quantity is stored at the database server 14 of the electronic stamp providing system 10. In a step S68, the electronic stamp providing system 10 computes the quantity transmitted per the advertisement item, and requests a corresponding advertising owner to pay advertising rates. At this time, the advertising owner can confirm the exposure quantity of his/her own online advertisements by remote control in real time.

The receiver, who received the electronic mail with the electronic stamp, receives the online advertisement through the advertisement providing window 60. The receiver may be induced to more actively participate in the online advertisement by having the electronic stamp providing system 10 present an amount to be paid if the online advertisement is received. If the agreement for the participation of the online advertisement together with the reception of the electronic mail is selected, the least receiver basic information is inputted, receiving contents of the electronic mail, therefore it is sensed by the electronic stamp providing system 10 and stored at the database server 14 information that, how many times somebody has connected to some advertisement items, etc.

Such an electronic stamp circulated through the electronic mail is increased, or multiplied, by user individuals in a geometrical progression, to thus actively promote the online advertisement marketing activity of enterprises. A currently needed customized advertisement is provided as the object only of consumers who have indicated an active participation intention for the advertisement based on the receiver selection system through a medium of the electronic stamp, therefore an effect of the advertisement can be heightened. Further, with regard to an expenditure of the advertising charges, the online advertisement is provided to a consumer group having the participation intention for the marketing activity, accordingly more effective concentrated advertisement having a high reaction rate is provided and the advertising owner party can operate the expenditure of the advertising charges more reasonably.

As afore-mentioned, in accordance with the present invention, in the electronic stamp providing system, a stamp image similar to a visual appearance of a stamp realistically used without a direct advertising exposure to a receiver can be appended to an electronic stamp. Thereby, an imagination similar to a general letter dispatch is given so as to provide a familiarity to a transmitter or a receiver of an electronic mail. In addition, the advertisement is provided to only a receiver who wants to receive the advertisement through the electronic stamp, whereby this invention has an increased advertising effect and a different nature in comparison with a partially compulsory advertising mail such as a conventional spam mail, or a banner type advertisement.

Although the invention has been shown and described with respect to the preferred embodiments, it will be understood by those skilled in the art that various changes and modifications may be made without departing from the spirit and scope of the invention as defined in the following claims.

What is claimed is:

1. An electronic stamp method, comprising the steps of:
displaying an electronic stamp image on a system of a first system user;
providing means for said first system user to append said electronic stamp image to an outgoing electronic mail message; and
when said first system user appends said electronic stamp image to an outgoing electronic mail message and when a recipient of said electronic mail message clicks on the display in the recipient's system of the electronic stamp image in the received electronic mail message, then displaying an online advertisement on the recipient's system.

2. The method of claim 1, said step of displaying an electronic stamp image on the system of a first system user further comprising:
activating an electronic stamp program on the first system user's system.

3. The method of claim 1, said step of providing means for said first system user to append said electronic stamp image further comprising:
downloading an electronic stamp program from a server to the system of said first user.

4. The method of claim 1, appending said electronic stamp image to the outgoing electronic message further comprising:
appending identification information corresponding to said electronic stamp image to the electronic message.

5. The method of claim 4, said identification information including an identification field of the first system user.

6. The method of claim 4, said identification information including the electronic mail address of the first user.

7. The method of claim 4, said identification information including an identification field for the copyright holder of the stamp image graphic.

8. The method of claim 4, said identification information including an identification field of a server to be contacted by the recipient's system.

9. The method of claim 4, said identification information being only a representative identification field uniquely associated with the electronic stamp image.

10. The method of claim 1, further comprising the step of:
downloading data for the electronic stamp image from a server to the system of the first user.

11. The method of claim 1, further comprising the step of:
providing means for said first system user to create the electronic stamp image.

12. The method of claim 11, further comprising the step of:
uploading data for the electronic stamp image created by the first user to a server; and
downloading data for the electronic stamp image created by the first user from said server to a system of a second user.

13. The method of claim 1, said electronic stamp image having the form of a perforated stamp.

14. The method of claim 2, said electronic stamp program being automatically activated when an electronic mail program is executed by the first user.

15. The method of claim 1, said step of displaying the online advertisement on the recipient's system further comprising sending data for the online advertisement from a server to the recipient's system.

16. The method of claim 15, further comprising the step of:
after displaying the online advertisement on the recipient's system, then sending an advertisement reception result from the recipient's system to said server.

17. The method of claim 1, said step of displaying an electronic stamp image on the system of a first system user further comprising:
displaying a menu having a plurality of electronic stamp images.

18. The method of claim 10, said step of downloading data for the electronic stamp image further comprising:
displaying a menu having a plurality of electronic stamp images.

19. The method of claim 18, said step of downloading data for the electronic stamp image further comprising:
providing an image button corresponding to an electronic stamp image on the menu.

20. The method of claim 1, said means for said first system user to append said electronic stamp image to an outgoing electronic mail message further comprising:
means for dragging-and-dropping the displayed electronic stamp image into a composing window for the electronic mail message.

21. The method of claim 1, further comprising:
customizing the online advertisement on the recipient's system based on data about the recipient.

22. The method of claim 21, further comprising:
after the recipient of said electronic mail message clicks on the display of the electronic stamp image and before displaying the online advertisement on the recipient's system, sending data input by the recipient to a server.

23. An electronic stamp method, comprising the steps of:
displaying an electronic stamp image on the system of a first system user;
providing means for said first system user to append said electronic stamp image to an outgoing electronic mail message; and
when said first system user appends said electronic stamp image to an outgoing electronic mail message and when a recipient of said electronic mail message clicks on the display of the electronic stamp image in the received electronic mail message, then displaying an advertisement providing window on the recipient's system.

24. The method of claim 23, further comprising:
offering in the advertisement providing window a monetary amount to be paid for reception of an online advertisement.

25. The method of claim 23, further comprising:
transmitting data entered in the advertisement providing window to a server; and
customizing an online advertisement based on data about the recipient; and
displaying the customized online advertisement on the recipient's system.

26. An electronic stamp system, comprising:
an electronic stamp server, said electronic stamp server comprising:
means for displaying an electronic stamp image on a first system of a first system user;
means for said first system user to append said electronic stamp image to an outgoing electronic mail message; and
means for displaying an online advertisement on the recipient's system when said first system user appends said electronic stamp image to an outgoing electronic mail message and when a recipient of said electronic mail message clicks on the display of the electronic stamp image in the received electronic mail message; and
a database server connected to said electronic stamp server, said database server comprising:
means for storing identification information of the electronic stamp; and
means for storing information on the display of online advertisements by the electronic stamp server.

27. The system of claim 26, further comprising said first system, said means for displaying an electronic stamp image being contained in an electronic stamp program stored in said electronic stamp server for transmission to said first system.

28. The system of claim 26, said identification information including an identification field of the first system user, an electronic mail identification field of the first system user, an identification field of a copyright holder of an electronic stamp image, a server identification field, a provider identification field of an electronic mail service, and address identification field of a server for providing the data for the online advertisement.

29. The system of claim 28, said database server having means for associating a unique representative identification field with said identification information.
